(19) United States
(12) Patent Application Publication
(10) Pub. No.: US 2006/0225015 A1
(43) Pub. Date: Oct. 5, 2006

(54) Various methods and apparatuses for flexible hierarchy grouping

(76) Inventors: Kamil Synek, Sunnyvale, CA (US); Jay S. Tomlinson, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/097,027

(22) Filed: Mar. 31, 2005

(51) Int. Cl. G06F 17/50

(52) U.S. Cl. 716/8

(57) ABSTRACT

Methods and apparatuses are described for incorporating floor planning information into a configuration process by generating a definition of a floor plan grouping of interconnect components during a front-end view design process for the interconnect. Further, a user is permitted to combine components from separate IP block representations of interconnects during the front-end view design process, based upon physical location of the grouping of the components making up the interconnects on the chip.

### FIELD OF THE INVENTION

Aspects of embodiments described herein apply to the development process of electronic systems, especially Systems on a Chip.

### BACKGROUND

In computer networks, internetworking, communications, integrated circuits, etc., where there is a need to communicate information, there are interconnections established to facilitate the transfer of the information. Interconnects may provide the physical communication network between two agents such as agents of Intellectual Property (IP) blocks. When designing systems that comprise such IP blocks and interconnects, the physical layout of IP blocks and its corresponding interconnects typically occur after the design/architecture and simulation stages are complete. Such an approach can potentially require revisions to the original design and simulation stages if it is not physically possible to place the components in such a way as to properly represent the original design. For example, a System on a Chip design may require the placement of components in such a way that is not physically possible to connect the various IP blocks in the manner when the architectural design was generated for this System on a Chip. Thus, one design hierarchy description may be used during the front-end design process and then possibly manually re-organized into a different design hierarchy description for use in the back-end design process. Under the traditional approach, such a problem may not be noticed until after the design and simulation stages have completed. The design would then have to be revised as well as further simulation testing. This approach could drastically increase the overall timeline of a development project. Another approach may be needed, where the physical layout of components may be incorporated into the architectural design stage. Such an approach may catch potential design problems earlier on, such that revisions to the original design, additional simulation and regeneration of Netlists are avoided.

### SUMMARY OF THE INVENTION

Methods and apparatuses are described for incorporating floor planning information into a configuration process by generating a definition of a floor plan that groups interconnect components during a front-end view design process for the interconnect. Further, a user is permitted to combine components from separate IP block representations of interconnects during the front-end view design process, based upon physical location on a chip of the groups of the components making up the interconnects on the chip.

### BRIEF DESCRIPTION OF THE DRAWINGS

The present invention is illustrated by way of example and not limitation in the figures of the accompanying drawings, in which like references indicate similar elements and in which:

FIG. 1 illustrates a data model of an embodiment of two distinct IP blocks.

FIG. 2 illustrates a hierarchical view of an embodiment of the IP blocks from FIG. 1.

FIG. 3 illustrates a merged data model of an embodiment of the two distinct IP blocks from FIG. 1.

FIG. 4 illustrates a hierarchical view of an embodiment of the merged IP blocks of FIG. 3.

FIG. 5a illustrates a flow process of the steps for an embodiment of merging two distinct IP blocks into a single block of IP.

FIG. 5b illustrates a detailed flow process of an embodiment of FIG. 5a.

FIG. 6 illustrates a graphical user interface (GUI) view of an embodiment of an integration of a set top box SOC design.

### DETAILED DESCRIPTION

In the following description, numerous specific details are set forth, such as examples of specific protocol commands, named components, connections, types of burst simulations, etc., in order to provide a thorough understanding of the present invention. It will be apparent, however, to one skilled in the art that the present invention may be practiced without these specific details. In other instances, well known components or methods have not been described in detail but rather in a block diagram in order to avoid unnecessarily obscuring the present invention. Thus, the specific details set forth are merely exemplary. The specific details may be varied from and still be contemplated to be within the spirit and scope of the present invention.

A System on a Chip (SOC) may comprise multiple Intellectual Property (IP) blocks. Each IP block is capable of functioning independent from other components or IP blocks on the SOC. An SOC may contain a single interconnect core that is responsible for connecting and allowing each IP block to communicate. It may also be possible for an SOC to have two or more discreet interconnect cores. In general, floor planning information may be incorporated into an electronic system configuration process by generating a definition of a floor plan of groups of interconnect components during a front-end view design process for the electronic system. Further, a user is permitted to combine components from two or more separate Intellectual Property (IP) block representations of interconnects during the front-end view design process, based upon a physical location on a chip of the groups of components making up the interconnects on a chip. Thus, chip area information may be discerned and utilized during the architectural design stages of System on a Chip design. The same design hierarchy description may be used during the front-end view design process and the back-end file design process. The initial netlist generated includes the floor plan of groups of interconnect components information.

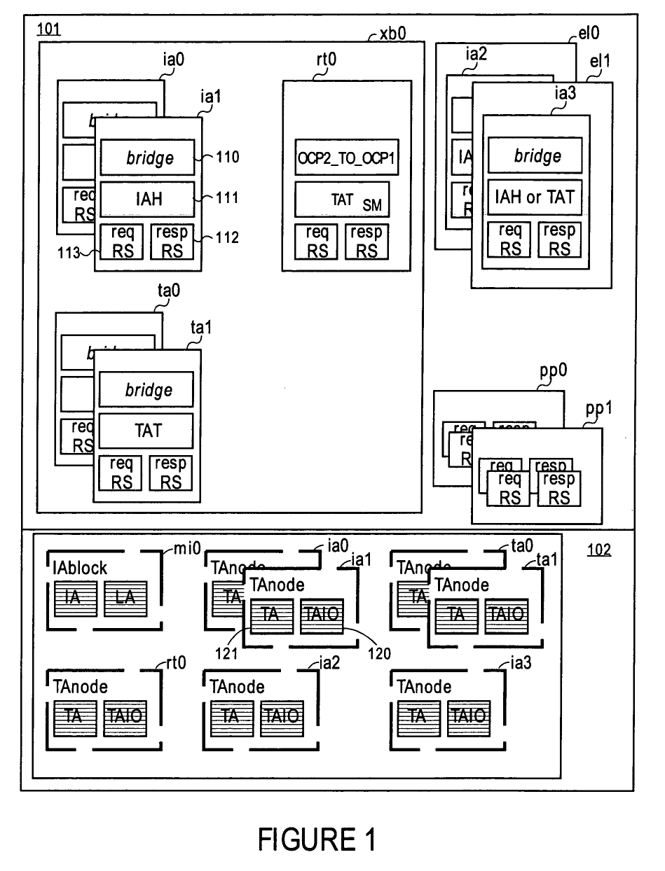

FIG. 1 illustrates a data model of an embodiment of two distinct IP blocks of interconnects each containing multiple hierarchical levels. Each level of hierarchy also contains multiple groups of components. Each of the IP blocks of interconnects in this example are independent from and capable of functioning on their own. FIG. 1 contains root IP blocks 101 and 102. Root block 101 contains groups' xb0, el0, el1, pp0, and pp1. Each of these groups sits one level below block 101, yet the three groups are all on the same level as each other. Group el0 contains group ia2, which resides inside group el0. Group el1 contains group ia3, which resides inside group el1. Group xb0 comprises many additional groups that sit one level below it. For example, there are groups' ia0, ia1, rt0, ta0, and ta1 that all sit one level below xb0 yet the five are on the same level as each other. Root IP block 102 also contains multiple levels of hierarchy, with each level containing one or more groups. One level below the root are eight groups; mi0, rt0, ia0, ia1, ia2, ia3, ta0 and ta1.

Each group within IP blocks 101 and 102 also contain one or more individual components. These components can be one of multiple things. For example group ia1 contains four components. Component 110 is a bridge, component 111 is an initiator agent (IAH), component 112 is a request relay station (req RS), and component 112 is a response relay station (resp RS). In one embodiment, each group from “ia” in block 101 is an instance of ia. Therefore group ia0 contains the same components as group ia1. In another embodiment ia0 and ia1 might not contain the same components. In another example, group ia1 from block 102 contains component 120, which is a target agent I/O block (TAIO) and component 121, which is a target agent (TA). In one embodiment each group from “ia” in block 102 is an instance of ia. Therefore group ia0 contains the same components as group ia1. In another embodiment ia0 and ia1 might not contain the same components.

Thus, permitted an SOC design engineer to combine components from two or more separate Intellectual Property (IP) block representations of interconnects during the front-end view design process, based upon a physical location on a chip of the groups of components making up the interconnects on a chip provides several benefits. This allows the dynamic addition of flexible components into the design description by combining sub-components from different IP blocks and different levels in the design hierarchy. Later in the SOC design stages, this allows flexible traversals (i.e. simulation and testing) of the design hierarchy depending on the stage of the design flow: with or without dynamic components. The SOC IP generator may allow different views of the design hierarchy to co-exist so that the floor plan grouping of information can be incorporated into the front-end design process. This allows the initial netlist generated to include floor plan grouping information without the need for an additional netlist re-organization step.

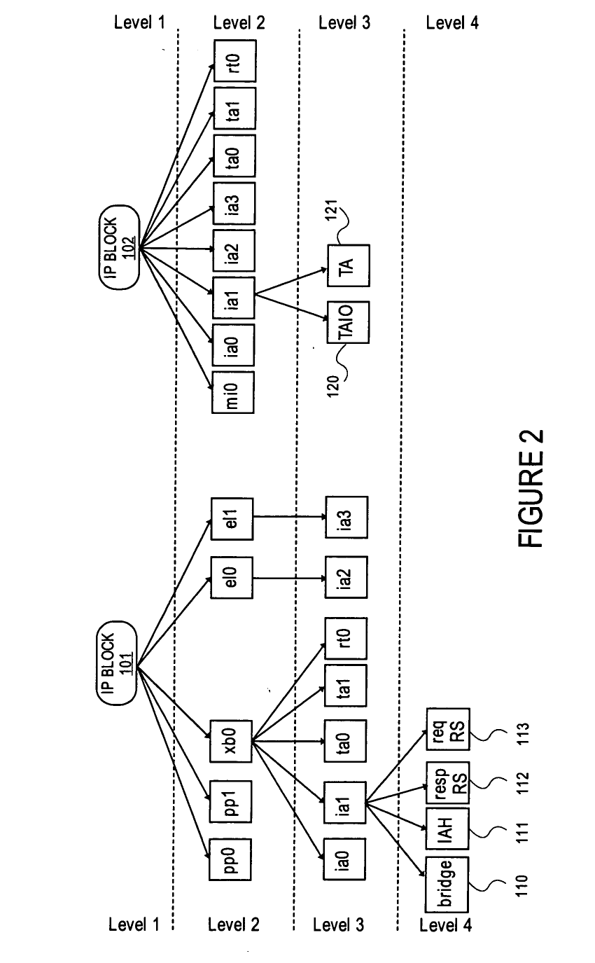

FIG. 2 illustrates a hierarchical view of an embodiment of various levels from FIG. 1 and the individual IP blocks and groups contained therein. As shown in Level 1, there exists root IP blocks 101 and 102. Beginning with root IP block 101 there are three groups that sit one level below (Level 2). These groups consist of el0, el1, xb0, pp0 and pp1. Group el0 contains group ia2, which resides inside of el0. Group el1 contains group ia3, which resides inside of el1. Groups ia0, ia1, ta0, ta1 and rt0 all sit below xb0. Finally, one level below (Level 4) are groups 110, 111, 112, 113, which sit below and inside ia1. They also reside in ia0, but are not shown in FIG. 2, for diagram simplicity.

Next there is root IP block 102, which sits on the same level as root IP block 101. One level below (Level 2) there are eight groups: mi0, rt0, ia0, ia1, ia2, ia3, ta0 and ta1 which all sit below IP block 102. One level below (Level 3) are groups 120 and 121, which sit below and inside of ia1. They also reside in ia0, but are not shown in FIG. 2, for diagram simplicity. Note: In this embodiment, IP block 102 does not have any components that reach down to Level 4. This hierarchy is only an example of one embodiment. The number of levels, root IP blocks and groups are not restrictive. There could many more or less in another embodiment.

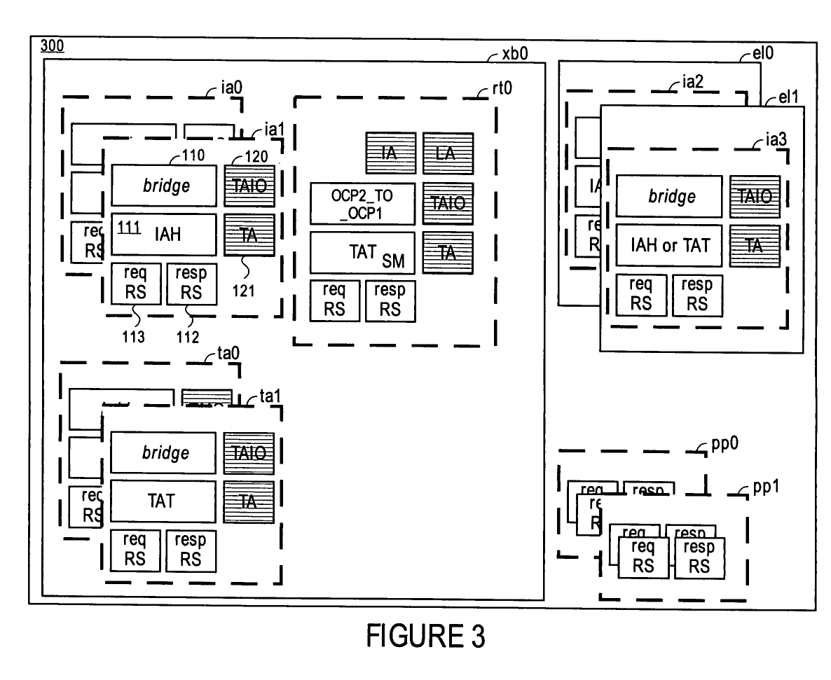

FIG. 3 illustrates a merged data model of one embodiment of a merged configuration of components from IP blocks 101 and 102. In FIG. 1, IP block 101 and 102 function as independent blocks or entities. In FIG. 3, the two component blocks are being merged into a single IP block 300, or system, such that the two previously independent blocks now function as a single IP block. In one embodiment, IP blocks 101 and 102, though independent from one another, communicate with each other. For example component 121 from block 102 may communicate with component 111 from block 101. The distance between them is long, hence an interconnect connecting them is equally long. Merging the two IP blocks allows components 111 and 121 to be located physically closer to each other. This may reduce the interconnect length between components 111 and 121 as well as reduce the time required for communications to reach each other.

Another benefit of merging both IP blocks is to reduce the amount of physical chip space required for placement of the groups, their components and the interconnects connecting them. For example, the physical space required for system 300 of FIG. 3 is substantially smaller than the physical space required for independent IP blocks 101 and 102 of FIG. 1. However, system 300 still contains all the components of IP blocks 101 and 102.

In FIG. 3, there exists the same level hierarchy that was present in IP block 101. The difference is that the individual components of the groups from block 102 are merged into the corresponding groups of block 101. For example, the components of group ia1 from block 102 have been added into group ia1 from block 101. This can be shown with the addition of components 120 and 121 into ia1 of system 300. So group ia1 of FIG. 3 comprises components 110, 111, 112, 113, 120 and 121. This holds true for all other components of IP block 102. All the components from group ta1 of block 102 now reside in group ta1 of system 300. All the components from group ta0 of block 102 now reside in group ta0 of system 300. All the components from group ia0 of block 102 now reside in group ia0 of system 300. All the components from group ia3 of block 102 now reside in group ia3 of system 300. All the components from group ia2 of block 102 now reside in group ia2 of system 300. All the components from groups mi0 and rt0 of block 102 now reside in group rt0 of system 300. (Note: To better distinguish which components came from what IP block, all components with horizontal lines depict individual components that were previously found in IP block 102 from FIG. 1. All components without horizontal lines are individual components that were previously found in IP block 101 from FIG. 1.)

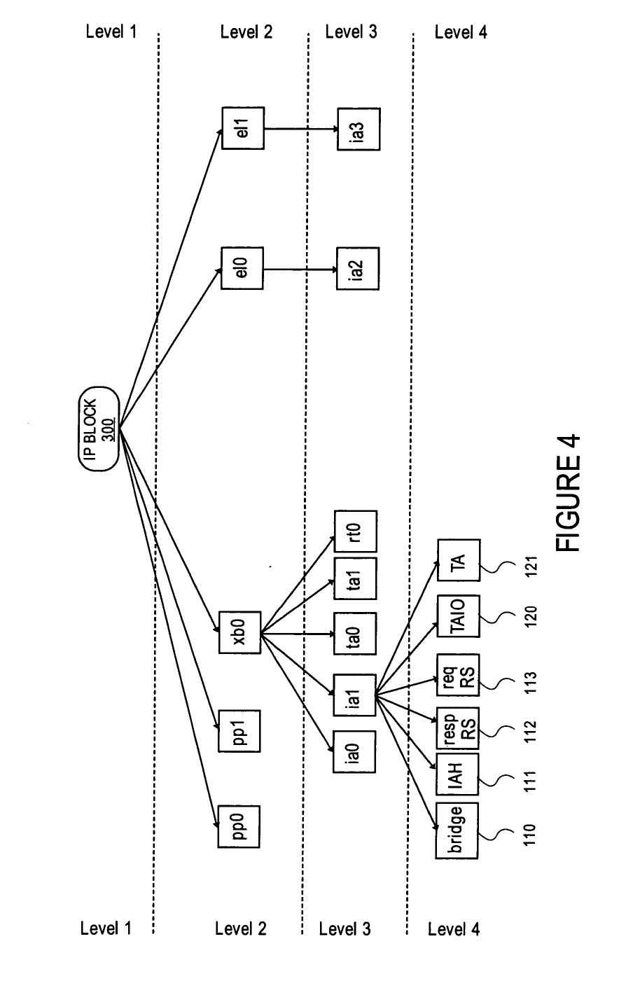

FIG. 4 illustrates a hierarchical view of an embodiment of various levels from FIG. 3 and the individual groups contained therein. As shown in Level 1, there exists the new group 300. One level lower (Level 2) are five groups el0, el1, xb0, pp0 and pp1. Group el0 contains group ia2, which resides inside of el0 and is one level lower (Level 3) than el0. Group el1 contains group ia3, which resides inside of el1 and is one level lower (Level 3) than el1. Groups ia0, ia1, ta0, ta1 and rt0 all sit one level below xb0 on Level 3. Lastly, the groups 110, 111, 112, 113, 120 and 121 all sit one level below ia1 on Level 4. Both ia0 and ia1 contain the groups 110, 111, 112, 113, 120 and 121, since ia0 and ia1 are instances of the same component, but the groups inside ia0 are not shown for diagram simplicity.

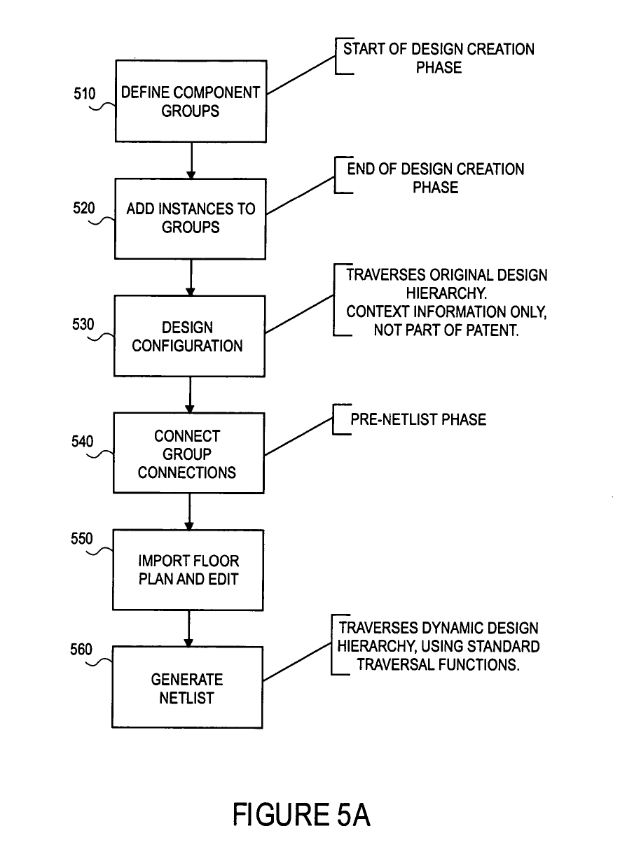

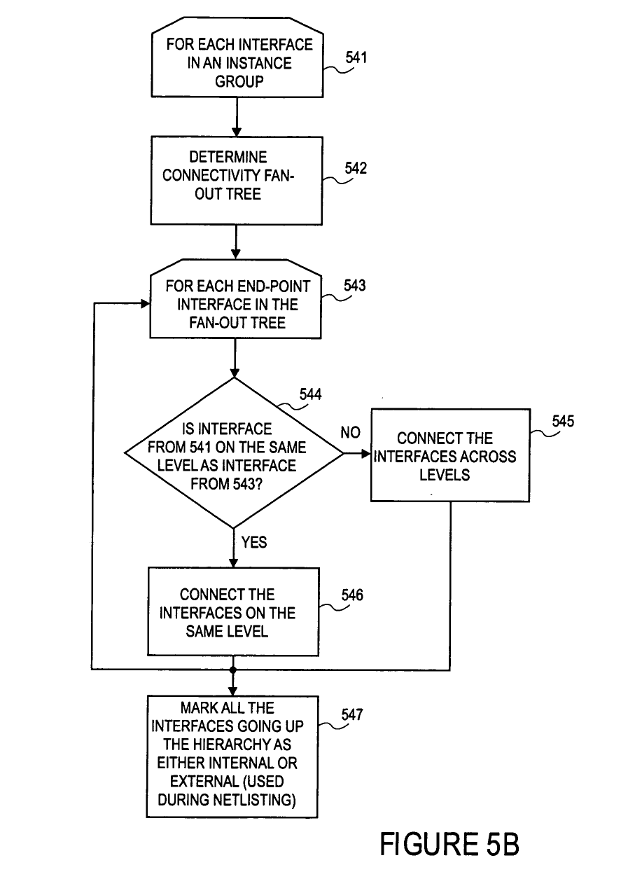

FIG. 5a illustrates a flow process for an embodiment of dynamically designing a System on a Chip (SOC). Traditionally, there exist two major stages of SOC design: front-end processing and back-end programming. Front-end processing consists of the design and architecture stages, which includes design of the SOC schematic. The front-end processing may include connecting models, configuration of the design, simulating and tuning during the architectural exploration. The design is simulated and tested. Front-end processing traditionally includes simulation of the circuits within the SOC and verification that they work correctly. The integration of the electronic circuit design may include packing the cores, verifying the cores, simulation and debugging.

Back-end programming traditionally includes programming of the physical layout of the SOC such as placing and routing, or floor planning, of the circuit elements on the chip layout, as well as the routing of all interconnects between components. Thus, the floor plan may be generated imported and edited. After this, the design may be outputted into a Netlist of one or more hardware design languages (HDL) such as Verilog, VHDL or Spice. A Netlist describes the connectivity of an electronic design such as the components included in the design, the attributes of each component and the interconnectivity amongst the components. After the netlist is generated synthesizing may occur. Accordingly, back-end programming further comprises the physical verification of the layout to verify that it is physically manufacturable and the resulting SOC will not have any function-preventing physical defects. If there are defects, the placement of circuit elements and interconnect routing is revisited, which requires one or more revisions to the Netlist. Such a process can lead to increased design time, since the physical placement of the components happens much later in the design stages.

An improvement over the prior art allows for portions of the back-end programming to concurrently occur during the front-end processing. This avoids making revisions to the Netlist, which saves time. In essence, the floor planning information is incorporated into the front-end configuration processing. Thus, the SOC may be tuned with floor plan data imported for edit before a Netlist is created and ready for synthesis. Further, reductions in chip area and timing are possible during the design and configuration processes through the incorporation of floor plan information into the design description.

In one embodiment, FIG. 5a illustrates the flow process taken by a SOC compiler when merging components from two distinct IP blocks such as block 101 and 102 from FIG. 1 into a single system such as system 300 from FIG. 3. The first three steps blocks 510-530 are part of the front-end view processing and incorporate the processes described above.

The first step in FIG. 5a is defining component groups 510. This is the start of the design creation phase. In this step, each group of components from block 101 and 102 are defined in template form. Each distinct group is defined with its own parameters and the types and number of individual components contained within the group. In one embodiment an object, as in object-oriented design, is defined in a way that acts as a template of the group's characteristics, but without actually creating an instance of the group. By defining a template of a group, the structure is being defined but not an actual instance of the group. An example of this step would be defining a group template called “ia” that contains a bridge, IAH, req resp, TA, and TAIO. During this step only the structure of the group exists, without any instances of it.

There is no limit to the number of group templates that may be created, or the size and complexity of each group template. Further it is possible to create groups within another group. For example: a group type called “xb” may be created in which group type “ia”, “ta” and “rt” may exist inside of group “xb”. In one embodiment, there may only be a single group consisting of a single component. In another embodiment there could be hundreds of groups, with each group containing multiple components and many groups existing inside other groups.

In the next step, instances of groups are created 520 as well as defining how each component will connect to each other during a merge from two distinct IP block into one. During this step, instances of each group type are created along with the specific details of the parameters of each group type. For example, IP block 101 contained a group template named “ia” that was defined in step 510. In this step, two instances of group template “ia” are created. They are called ia0 and ia1. Each one contains the six components that were defined in step 510 in regards to group template “ia”. So group instance ia0 and ia1 will each have a bridge, an IAH, a req RS a resp RS, a TA and a TAIO.

Further, this step includes the defining of interconnects between each component and the parameters (e.g. bandwidth, number of pipes, etc) of the interconnects. For example, there may be an interconnect between the bridge from ia1 in IP block 101 and TA from ia1 in IP block 102.

The other important part of step 520 is defining how components from each group in IP block 101 and 102 will be merged. For example, IP block 101 contains a group ia1 which comprises a bridge, IAH, req RS and resp RS. IP block 102 also has a group ia1, which comprises components TA and TAIO. Defining how the components will be merged may state that components TA and TAIO from IP block 102 will be merged into ia1 from IP block 101. Hence, the resulting merged group ia1 would comprise components bridge, IAH, req RS, resp RS, TA and TAIO. This can be seen in FIG. 3. By the end of this step, IP blocks 101 and 102 have been created with all their instances, as well as defining how they shall be merged later on. The current state of IP blocks 101 and 102 can be seen in FIG. 1. (Note: Step 520 does not include the actually merging of component groups, but only defining how to merge the groups later on.) The end of step 520 marks the end of the design creation phase.

However, a key portion of step 520 is that a user is permitted to combine components from two or more separate Intellectual Property (IP) block representations of interconnects based upon a physical location on a chip of the groups of components making up the interconnects on the chip. Thus, chip area information may be discerned and utilized during the architectural design stages of System on a Chip design. The same design hierarchy description used during this front-end view design process can be used again during the back-end file design process.

In the next step, design configuration 530 occurs. User-specific details of each component are defined. The user is not required to know how the merged IP blocks will look. The user may only have to see the two independent blocks of IP and define the configuration details with this knowledge. Once the merge occurs, the user-specified parameters will be incorporated automatically without the user needing to be involved. The design hierarchy may be traversed through simulation and testing. However, the area and timing constraints supplied also incorporate floor plan information into the design hierarchy description.

In the next step, the component groups are connected together 540 based on their eventual physical layout after the merge occurs. At this point in the flow process of FIG. 5a, there are two distinct and independent entities or IP blocks. The components contained in each IP block comprises interconnects linking them together. Parameters of these interconnects have also been defined such as bandwidth and the number of pipes for each interconnect. The layout of these interconnects will of course change once IP block 101 and 102 are merged. For example the physical distance between the bridge in ia1 of block 101 and TA in ia1 of block 102 are longer now than will be after the merge. In result, the layout of the interconnect connecting them will also change. However the parameters of the actual interconnect shall not change, only its path connecting the two components.

FIG. 5b illustrates a detailed flow process of an embodiment of step 540 from FIG. 5a. For each instance of a component group 541, the connectivity fan-out tree is determined 542. In this step, all of the interconnects from a specific group are determined and whether these interconnects connect the group to other groups from the same hierarchy level or different (higher or lower) levels. For each end-point in the connectivity interface of the group's fan-out tree 543 a loop exists until all the end-points in the connectivity interface are connected. The first step in the loop determines whether the interface from step 541 is on the same hierarchy level as the interface from step 543, 544. If the interfaces are from the same level, the interfaces are connected on the same level 546. If the interfaces are from different levels, they are connected across the differing levels 545. Further, the flow process returns to step 543 and continues the loop until there are no more interconnects. Once all the interfaces have been connected, all interfaces going up the hierarchy are marked as internal or external 547. This information is used when generating the Netlist.

Once the flow process of FIG. 5b is complete, floor plan data is imported and may be edited 550 to make any changes before the Netlist is generated. Allowing for floor plan data editing before the Netlist is generated eliminates the need to generate multiple Netlists. In the prior art, a Netlist may be generated only to find that the floor plan data needs editing. If such edits are required, a new Netlist must be generated. Allowing floor plan data editing before the Netlist is generated eliminates such an issue. Next, the Netlist is generated 560 in FIG. 5a. Netlist creation entails a detailed walkthrough of the complete hierarchy to identify each group, its components and the connections between them. The output of the Netlist is a descriptor language, which describes the entire hierarchy and its connectivity. In the prior art, a Netlist only contained information of the components within a design and its connectivity. However, it did not describe the physical placement of each component interconnect. The Netlist generation of step 560 allows for the inclusion of physical placement information. In other words, floor planning information is being added to the actual design.

Another aspect of the Netlist generation of step 560 is that component groups are treated as dynamic and not static. This allows for components within a group to easily be moved to other groups if the design changes. In the prior art, components within a group are static. Hence, once they are defined, they cannot be moved to other groups.

Another advantage of the Netlist generation of step 560 is that multiple views or representations of the hierarchy can be maintained. For example, in FIG. 1 there were two original design hierarchies one of IP block 101 and another of IP block 102. In FIG. 3, there was a merging of the previous two hierarchies resulting in a single IP block 300. The Netlist can maintain all three representations of the hierarchy. Further, a user is able to make changes to one of the hierarchies while leaving the original alone and creating a new representation of it. In another embodiment a user can swap between looking at different representations of a single hierarchy. The inclusion of multiple views provides as advantage over the prior art, which would use a single design hierarchy description during the front-end design process. The prior art would then re-organize (possibly manually) the design hierarchy into a different description for use in the back-end design process.

Another advantage over the prior art is that the resulting Netlist is synthesizable. In the prior art, Netlists only contained high-level constructs of the overall design. High-level constructs would then have to be converted to gate-level details when the design is submitted to manufacturing. Having synthesizable Netlists containing gate-level details increases efficiency in the manufacturing stage by eliminating the high-level to gate-level conversion step. Thus, the initial Netlist incorporates component and structural information that is synthesizable down to a gate level.

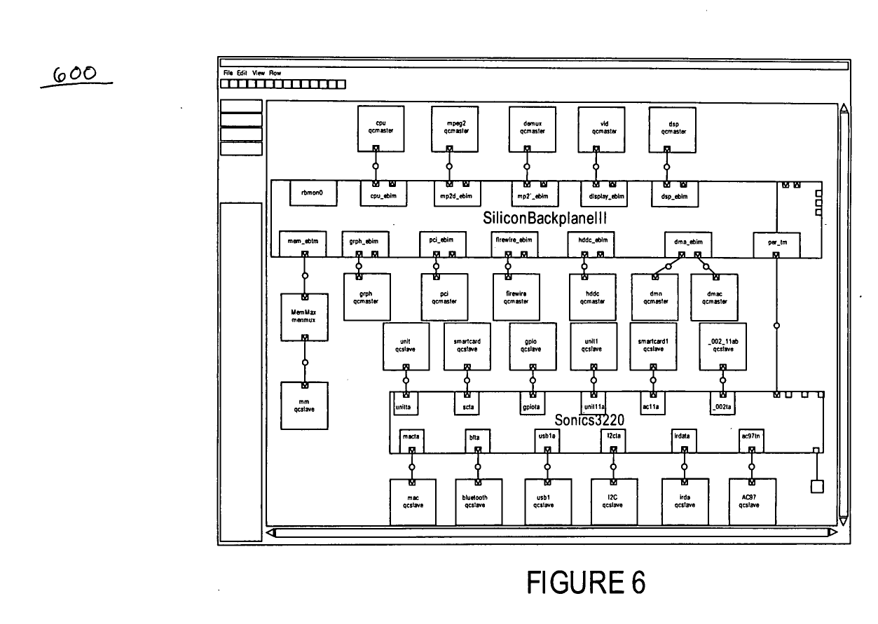

FIG. 6 illustrates a graphical user interface (GUI) view of an embodiment of the integration of a set top box SOC design. The example set top box SOC design has a multiple IP cores with two interconnect IP blocks all in a single System on a Chip. The groups of interconnect components from the two separate IP block representations of interconnects are combined during the front-end view design process by using the same design hierarchy description during the front-end view design process and the back-end file design process.

The example System on a Chip may have IP cores such as a CPU core, a MPEG encoder/decoder core, a memory core, a Digital Signal Processor core, a Universal Service Bus core, a blue tooth core, a first interconnect IP core facilitating communications between a first set of IP cores, and a second interconnect IP core facilitating communications between a second set of IP cores as well as communications between the two IP interconnect cores.

In one embodiment, the software used to facilitate aspects of SOC design process can be embodied onto a machine-readable medium. A machine-readable medium includes any mechanism that provides (e.g., stores and/or transmits) information in a form readable by a machine (e.g., a computer). For example, a machine-readable medium includes read merely memory (ROM); random access memory (RAM); magnetic disk storage media; optical storage media; flash memory devices; DVD's, electrical, optical, acoustical or other form of propagated signals (e.g., carrier waves, infrared signals, digital signals, EPROMs, EEPROMs, FLASH, magnetic or optical cards, or any type of media suitable for storing electronic instructions. The information representing the apparatuses and/or methods stored on the machine-readable medium may be used in the process of creating the apparatuses and/or methods described herein. For example, the information representing the apparatuses and/or methods may be contained in an Instance, soft instructions in an IP generator, or similar machine-readable medium storing this information.

The IP generator may be used for making highly configurable, scalable System On a Chip inter-block communication systems that integrally manages data, control, debug and test flows, as well as other applications. In an embodiment, an example intellectual property generator may comprise the following: a graphic user interface; a common set of processing elements; and a library of files containing design elements such as circuits, control logic, and cell arrays that define the intellectual property generator. In an embodiment, a designer chooses the specifics of the interconnect configuration to produce a set of files defining the requested interconnect instance. An interconnect instance may include front-end views and back-end files. The front-end views support documentation, simulation, debugging, and testing. The back-end files, such as a layout, physical LEF, etc are for layout and fabrication.

What is claimed is:

1. A machine readable medium that contains instructions, which when executed by the machine cause the machine to perform the following operations, comprising:
permitting a user to incorporate floor planning information into a electronic system configuration process by generating a definition of a floor plan of groups of interconnect components during a front-end view design process for the electronic system; and
permitting a user to combine components from separate Intellectual Property (IP) block representations of interconnects during the front-end view design process, based upon a physical location on a chip of the groups of components making up the interconnects on the chip.

2. The machine readable medium of claim 1, further comprising:
permitting a user to supply area and timing constraints during the electronic system configuration process by incorporating floor plan information into a design hierarchy description.

3. The machine readable medium of claim 2, further comprising:
permitting a user to use the same design hierarchy description during the front-end view design process and a back-end file design process.

4. The machine readable medium of claim 1, further comprising:
permitting a user to generate an initial netlist to include the floor plan information of groups of interconnect components.

5. The machine readable medium of claim 4, wherein the initial netlist incorporates component and structural information that is synthesizable down to a gate level.

6. The machine readable medium of claim 1, wherein the front-end view design process includes support documentation, simulation, debugging, and testing.

7. The machine readable medium of claim 3, wherein the back-end file design process includes information such as a layout and a physical LEF.

8. The machine readable medium of claim 1, wherein the floor plan information is a physical layout of the electronic system on the chip.

9. The machine readable medium of claim 2, wherein the design hierarchy description may comprise multiple representations of the hierarchy that may be incorporated into an initial netlist.

10. An apparatus generated by the instructions executed by the machine readable medium of claim 1.

11. A method, comprising:
incorporating floor planning information into a electronic system configuration process by generating a definition of a floor plan of groups of interconnect components during a front-end view design process for the electronic system; and
combining components from separate Intellectual Property (IP) block representations of interconnects during the front-end view design process, based upon a physical location on a chip of the groups of components making up the interconnects on the chip.

12. The method of claim 11, further comprising:
supplying area and timing constraints during the electronic system configuration process by incorporating floor plan information into a design hierarchy description.

13. The method of claim 12, further comprising:
using the same design hierarchy description during the front-end view design process and a back-end file design process.

14. The method of claim 11, further comprising:
generating an initial netlist to include the floor plan information of groups of interconnect components.

15. The method of claim 14, wherein the initial netlist incorporates component and structural information that is synthesizable down to a gate level.

16. The method of claim 12, wherein the design hierarchy description may comprise multiple representations of the hierarchy that may be incorporated into an initial netlist.

17. An apparatus generated by the method of claim 11.

18. A System on Chip, comprising:
a plurality of IP cores,
a first interconnect IP core facilitating communications between a first set of Intellectual Property (IP) cores; and
a second interconnect IP core facilitating communications between a second set of IP cores as well as communications between the first and second interconnect cores, wherein components from the IP cores representing the first and second interconnects are combined during the front-end view design process, based upon a physical location on a chip of the groups of components making up the first and second interconnects on the chip.

19. The System on Chip of claim 18, wherein the second interconnect IP core further comprises supplying area and timing constraints during the front-end view design process for an electronic system by incorporating floor plan information into a design hierarchy description.

20. The System on Chip of claim 19, wherein the second interconnect IP core further comprises using the same design hierarchy description during the front-end view design process and a back-end file design process.

21. The System on Chip of claim 19, wherein the second interconnect IP core further comprises generating an initial netlist to include the floor plan information of groups of interconnect components.

22. The System on Chip of claim 21, wherein the initial netlist incorporates component and structural information that is synthesizable down to a gate level.

23. The System on Chip of claim 19, wherein the design hierarchy description may comprise multiple representations of the hierarchy that may be incorporated into an initial netlist.

24. An apparatus comprising:
means for incorporating floor planning information into a electronic system configuration process by generating a definition of a floor plan of groups of interconnect components during a front-end view design process for the electronic system; and
means for combining components from separate Intellectual Property (IP) block representations of interconnects during the front-end view design process, based upon a physical location on a chip of the groups of components making up the interconnects on the chip.
